(19) United States
(12) Patent Application Publication
(10) Pub. No.: US 2022/0234161 A1
(43) Pub. Date: Jul. 28, 2022

(54) ROTARY TOOL

(71) Applicant: MAKITA CORPORATION, Anjo-shi (JP)

(72) Inventors: Satoshi NINAGAWA, Anjo-shi (JP); Ryosuke OTANI, Anjo-shi (JP)

(73) Assignee: MAKITA CORPORATION, Anjo-shi (JP)

(21) Appl. No.: 17/556,610

(22) Filed: Dec. 20, 2021

(30) Foreign Application Priority Data
Jan. 22, 2021 (JP) 2021-009038

(51) Int. Cl. B24B 23/02

(52) U.S. Cl. CPC B24B 23/028

(57) ABSTRACT

A rotary tool includes simple wiring from the controller. A grinder includes a housing, a motor accommodated in the housing, a final output shaft accommodated in the housing to receive a tip tool and rotatable by the motor being driven, and a plurality of controllers accommodated in the housing. The plurality of controllers include at least a first controller receiving an electrical component of the grinder on an outer surface of the first controller. The electrical component performs an electrical operation.

### CROSS-REFERENCE TO RELATED APPLICATIONS

This application claims the benefit of priority to Japanese Patent Application No. 2021-009038, filed on Jan. 22, 2021, the entire contents of which are hereby incorporated by reference.

### BACKGROUND

### 1. Technical Field

The present disclosure relates to a rotary tool, such as a grinder or a polisher.

### 2. Description of the Background

A rotary tool (e.g., a grinder) that rotates a tip tool (e.g., a grinding disc) is described in, for example, Japanese Unexamined Patent Application Publication No. 2019-51582 (Patent Literature 1). The rotary tool includes a housing. The housing includes a cylindrical motor housing accommodating a motor and extending in the front-rear direction, a gear housing including a spindle as a final output shaft at the front of the motor housing, and a handle housing accommodating a switch and other components at the rear of the motor housing.

The housing accommodates a controller for controlling, for example, the drive of the motor. In the rotary tool described in Patent Literature 1, the controller is divided into two, or upper and lower controllers, located above and below a commutator for a rotor in the motor housing. This structure allows efficient use of the space in the motor housing.

### BRIEF SUMMARY

The controller is connected to electrical components of the rotary tool, such as sensors and lamps. Such components including sensors and lamps located away from the controller may use many wires drawn from the controller. This causes complicated wiring, involving more laborious assembly and a higher possibility of wire breakage.

One or more aspects of the present disclosure are directed to a rotary tool including simple wiring from a controller.

A first aspect of the present disclosure provides a rotary tool, including:

a housing;

a motor accommodated in the housing;

a final output shaft accommodated in the housing and configured to receive a tip tool, the final output shaft being rotatable by the motor being driven; and

a plurality of controllers accommodated in the housing, the plurality of controllers including at least a first controller receiving an electrical component of the rotary tool on an outer surface of the first controller, the electrical component being configured to perform an electrical operation.

The electrical component refers to either or both of an information input unit, such as a sensor or an operation unit, electrically connected to the controller to obtain information used by the controller to control the rotary tool, and an information output unit, such as a light emitter or an indicator, electrically connected to the controller to cause the controller to provide information used to operate the rotary tool.

The rotary tool according to the above aspect of the present disclosure includes simple wiring from the controller.

### BRIEF DESCRIPTION OF DRAWINGS

FIG. 1 is a perspective view of a grinder.

FIG. 2 is a longitudinal central sectional view of the grinder.

FIG. 3 is a plan view taken along line A-A in FIG. 2.

FIG. 4 is an enlarged cross-sectional view taken along line B-B in FIG. 2.

FIG. 5A is a top perspective view of a first controller.

FIG. 5B is a bottom perspective view of the first controller.

FIG. 6A is a top perspective view of a second controller.

FIG. 6B is a bottom perspective view of the second controller.

FIG. 7 is an enlarged cross-sectional view taken along line C-C in FIG. 2.

FIG. 8 is a perspective view of the grinder with a cover attached to a handle housing.

FIG. 9 is an exploded perspective view of the handle housing and the cover.

FIG. 10 is an enlarged cross-sectional view of the grinder in FIG. 8 showing screw bosses.

### DETAILED DESCRIPTION

An embodiment of the present disclosure will now be described with reference to the drawings.

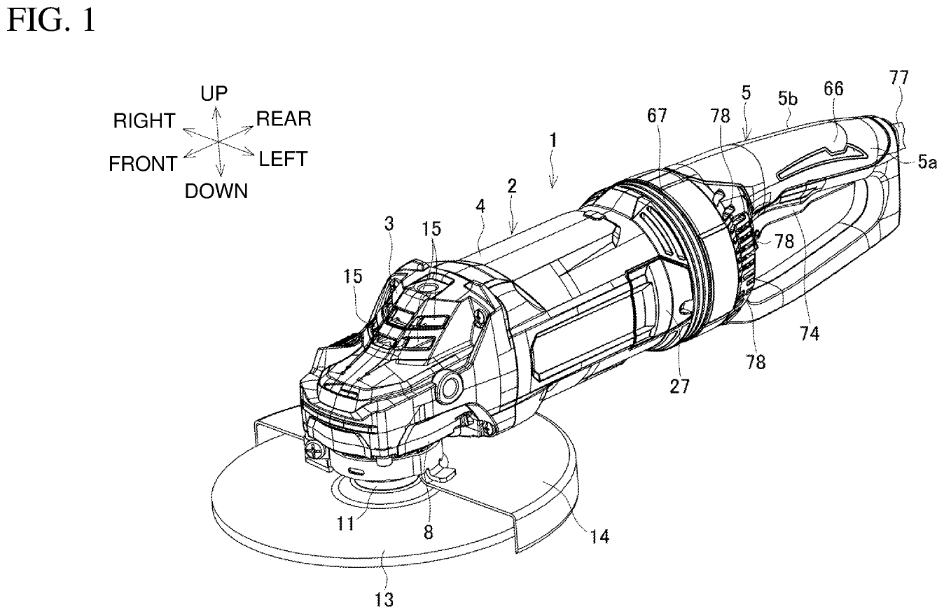

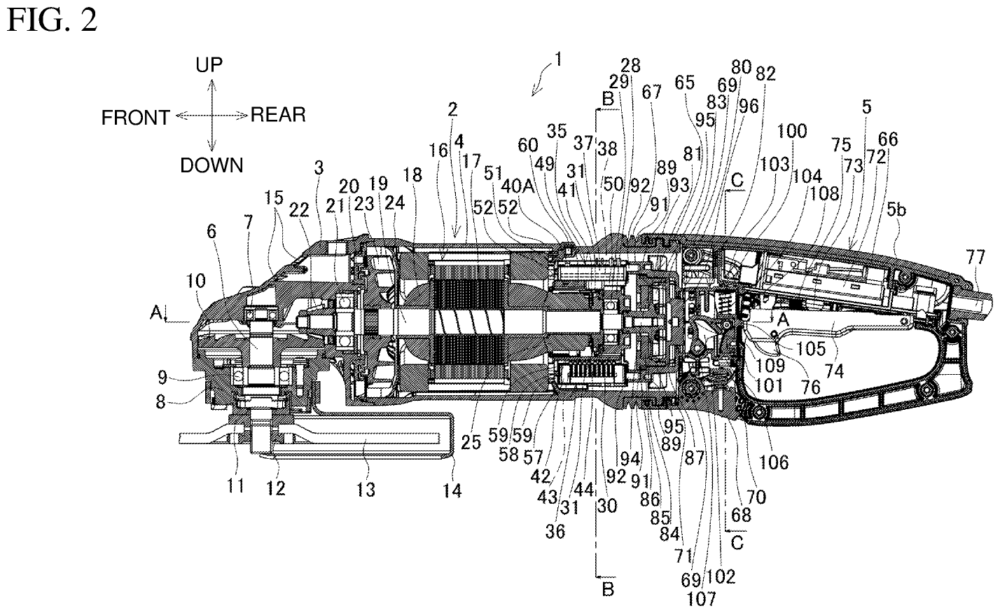

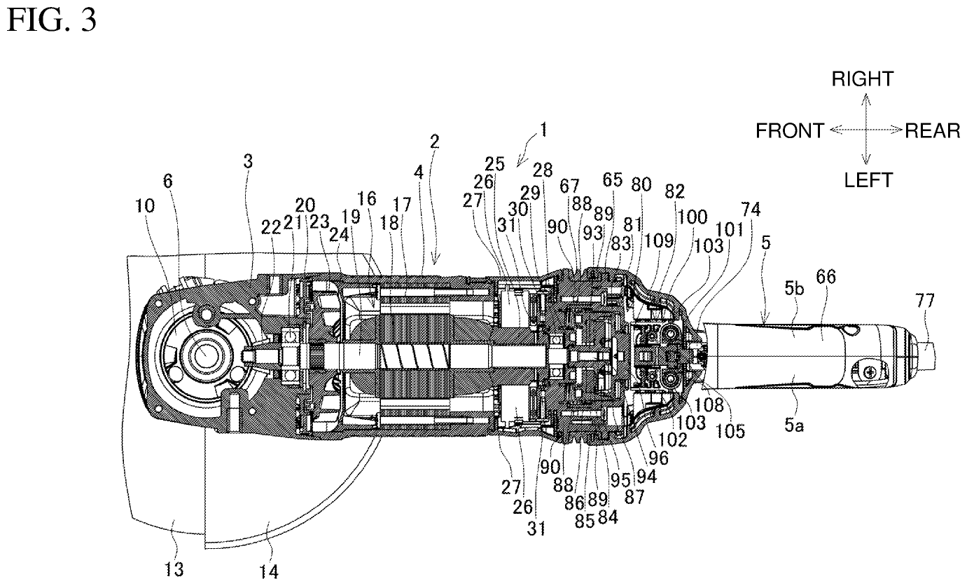

FIG. 1 is a perspective view of a grinder as an example rotary tool. FIG. 2 is a longitudinal central sectional view of the grinder. FIG. 3 is a cross-sectional view taken along line A-A in FIG. 2.

A grinder 1 includes a housing 2 including a gear housing 3, a motor housing 4, and a handle housing 5 in this order from the front.

The gear housing 3 includes a spindle 6. The spindle 6 is rotatably supported on an upper bearing 7 and a lower bearing 9 with its axis vertically extending. The upper bearing 7 is held in the gear housing 3. The lower bearing 9 is held on a retainer 8 attached to the bottom of the gear housing 3.

A bevel gear 10 is located on an upper portion of the spindle 6. The spindle 6 has a lower end protruding downward from the retainer 8 to receive a grinding disc 13 with an inner flange 11 and an outer flange 12.

The retainer 8 includes a wheel cover 14 to cover a rear half of the grinding disc 13. The gear housing 3 has multiple outlets 15 in the front surface.

The motor housing 4 accommodates a motor 16. The motor housing 4 is cylindrical and extends in the front-rear direction. The motor 16 includes a stator 17 and a rotor 18. The motor 16 is accommodated with the rotor 18 having an output shaft 19 extending frontward. The output shaft 19 extends through a partition 20 between the motor housing 4 and the gear housing 3 and is supported on a bearing 21 held in the gear housing 3. The output shaft 19 has a front end protruding into the gear housing 3 and receiving a bevel gear 22. The bevel gear 22 meshes with the bevel gear 10 on the spindle 6. A centrifugal fan 23 is fixed to the output shaft 19 rearward from the bearing 21. A baffle plate 24 is held rearward from the centrifugal fan 23 in the motor housing 4.

A commutator 25 is located at the rear of the rotor 18. A pair of carbon brushes 26 are held on the left and right of the commutator 25 in the motor housing 4. The carbon brushes 26 come in contact with the commutator 25. Brush caps 27 are located on the left and right of the carbon brushes 26. The brush caps 27 are fastened to the left and right surfaces of the motor housing 4 with screws. The brush caps 27 are detachable for, for example, replacing the carbon brushes 26.

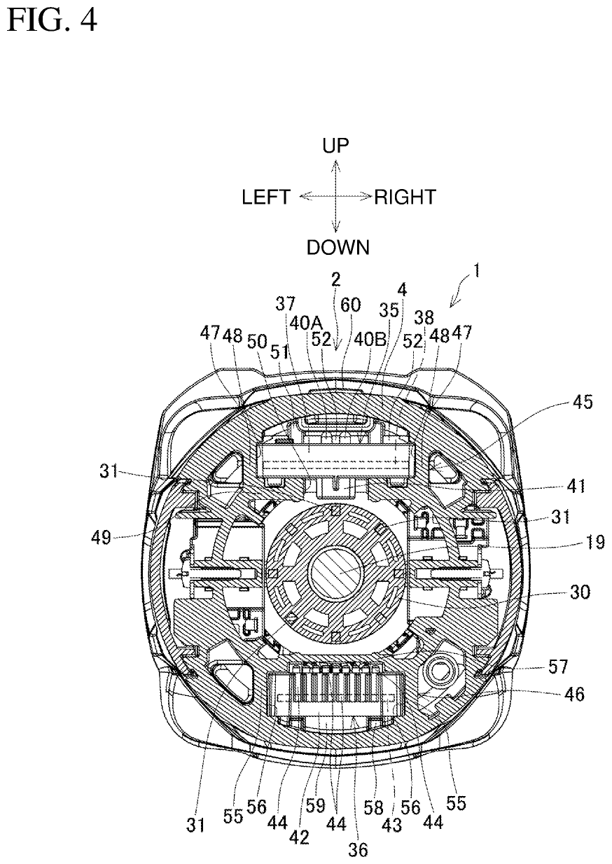

The shaft in the motor housing 4 has a rear portion supporting a bearing holder 28. The bearing holder 28 holds a bearing 29 to support the rear end of the output shaft 19. As shown in FIG. 4, a disc 30 is fixed to the output shaft 19 in front of the bearing 29. The disc 30 is coaxial with and perpendicular to the output shaft 19. The disc 30 includes eight permanent magnets 31 on the circumference at circumferentially equal intervals.

A first controller 35 is located at the rear of the rotor 18 above the commutator 25. A second controller 36 is located at the rear of the rotor 18 below the commutator 25.

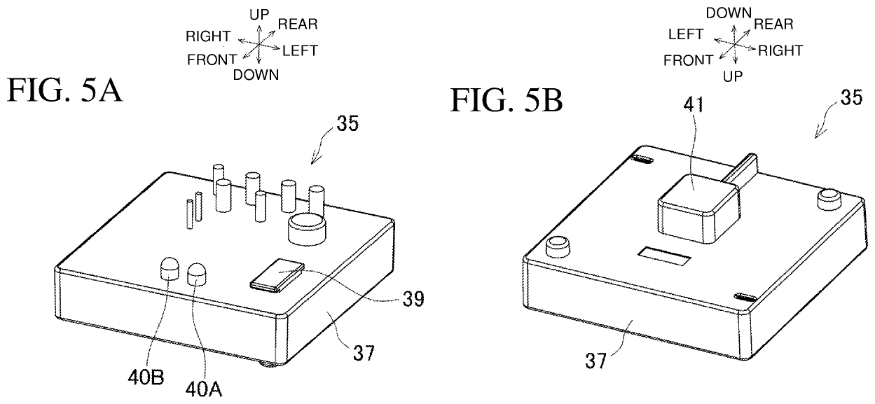

The upper first controller 35 mainly forms a control unit. As also shown in FIGS. 5A and 5B, the first controller 35 includes a resin case 37 rectangular as viewed from above. The case 37 accommodates a circuit board 38 (FIGS. 2 and 4) receiving electronic components (e.g., a microcomputer 39) and having its surface molded. The first controller 35 has an upper surface with two LEDs 40A and 40B protruding at the front. The LEDs 40A and 40B are green and red and laterally arranged on the circuit board 38. The first controller 35 has a lower surface receiving a pickup coil 41 at the center.

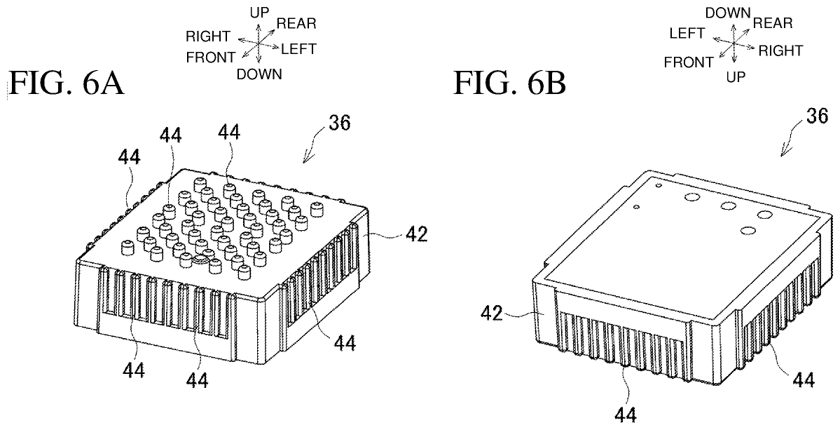

The lower second controller 36 mainly forms a power supply. As shown in FIGS. 6A and 6B, the second controller 36 includes an aluminum case 42 square as viewed from above. The case 42 accommodates a circuit board 43 (FIGS. 2 and 4) receiving heat-generating components such as triacs and field-effect transistors (FETs). The case 42 has upper, front, rear, left, and right surfaces with multiple projections 44. The projections 44 serve as a heat dissipator.

The first controller 35 and the second controller 36 have substantially the same length in the front-rear direction. The second controller 36 has a slightly smaller width than the first controller 35 in the lateral direction.

The first controller 35 is held on an upper holder 45 located above the rotor 18 in the motor housing 4. The second controller 36 is held on a lower holder 46 located below the rotor 18 in the motor housing 4.

The upper holder 45 includes a pair of left and right upper sidewalls 47. The upper sidewalls 47 extend downward from the upper inner surface of the motor housing 4. The upper sidewalls 47 have upper fitting grooves 48 on their surfaces facing each other. The first controller 35 has left and right portions fitted in the upper fitting grooves 48. The upper fitting grooves 48 extend in the front-rear direction.

A receiving wall 49 is between the lower ends of the upper sidewalls 47. The receiving wall 49 supports the lower surface of the first controller 35. The receiving wall 49 has a cutout 50 at the center to avoid interference with the pickup coil 41. The cutout 50 extends frontward from the rear end of the receiving wall 49. An upper front wall 51 is between the front ends of the upper sidewalls 47. The upper front wall 51 is a grid in contact with the front surface of the first controller 35. The upper front wall 51 has multiple through-holes 52.

The lower holder 46 includes a pair of left and right lower sidewalls 55. The lower sidewalls 55 extend upward from the lower inner surface of the motor housing 4. The lower sidewalls 55 have lower fitting grooves 56 on their surfaces facing each other. The second controller 36 has left and right portions fitted in the lower fitting grooves 56. The lower fitting grooves 56 extend in the front-rear direction. A protective wall 57 is between the upper ends of the lower sidewalls 55. The protective wall 57 covers the top of the second controller 36. A lower front wall 58 is between the front ends of the lower sidewalls 55. The lower front wall 58 is a grid in contact with the front surface of the second controller 36. The lower front wall 58 has multiple through-holes 59.

The first controller 35 and the second controller 36 respectively held on the upper holder 45 and the lower holder 46, above and below the output shaft 19, extend in the front-rear direction along the output shaft 19 at symmetric positions with respect to a point.

The pickup coil 41 on the first controller 35 is near the top of the disc 30 on the output shaft 19 to detect the magnetic field of the permanent magnets 31. The LEDs 40A and 40B are near the upper inner surface of the motor housing 4. A lens 60 is located on the motor housing 4 above the LEDs 40A and 40B. The lens 60 is insert molded onto the motor housing 4. The lens 60 guides light from the LEDs 40A and 40B outside the motor housing 4.

The handle housing 5 includes a pair of half housings 5a and 5b. The half housings 5a and 5b are fastened together laterally with screws with a rear end portion 65 of the motor housing 4 in between. The handle housing 5 includes a handle 66 at the rear end. The handle 66 extends rearward. A strip of anti-vibration rubber 67 is wound between the rear end portion 65 of the motor housing 4 and the handle housing 5. The anti-vibration rubber 67 allows the handle housing 5 to be elastically joined to the motor housing 4.

The handle housing 5 is rotatable about the rear end portion 65. The handle housing 5 has a lower surface with a lock button 68. The lock button 68 is pivotable about a lower screw boss 69. The lower screw boss 69 is one of upper and lower screw bosses 69 joining the handle housing 5. In the normal state, the lock button 68 being urged by a coil spring 70 has a front end pressing the rear end portion 65. Multiple engagement portions 71 are circumferentially arranged on the circumference of the rear end portion 65. The lock button 68 having the front end engaged with any of the engagement portions 71 prevents the handle housing 5 from rotating. With the rear end pushed toward the handle housing 5, the lock button 68 is disengaged at its front end and thus permits rotation of the handle housing 5.

The handle 66 holds a switch 72 inside. The switch 72 extends in the front-rear direction with a plunger 73 protruding downward. The handle 66 includes a switch lever 74 at the bottom. The switch lever 74 has a front end vertically pivotable about its rear end. Urged by a coil spring 75, the switch lever 74 is pivoted to a lower position. The switch lever 74 pivoted to the lower position causes the switch 72 to be off. The switch lever 74 is pushed upward with the hand gripping the handle 66 to push the plunger 73 that turns on the switch 72.

The switch lever 74 includes a lock lever 76 at the front end. The lock lever 76 is rotatable forward and backward. The lock lever 76 is rotatable to a position selected from an unlocking position, a neutral position, and a locking position. At the unlocking position, the lock lever 76 restricts the switch lever 74 from being pushed. At the neutral position, the lock lever 76 permits the switch lever 74 to be pushed. At the locking position, the lock lever 76 maintains the switch lever 74 in the pushed state.

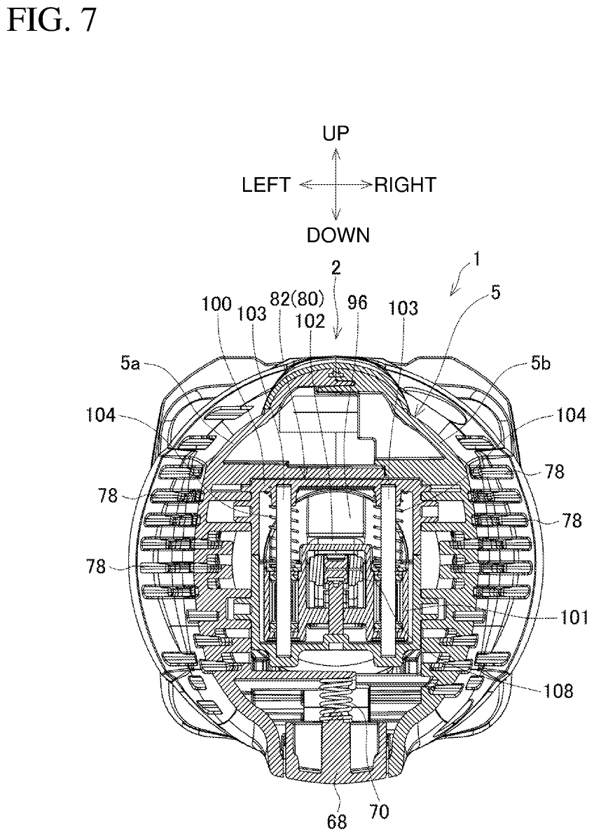

The handle 66 is connected to a power cable 77 at the rear end. As shown in FIGS. 1 and 7, the handle housing 5 has multiple inlet ports 78 in the left and right surfaces frontward from the handle 66. The inlet ports 78 are slits extending in the front-rear direction. The multiple inlet ports 78 are arranged at predetermined intervals in the circumferential direction of the handle housing 5.

The motor housing 4 and the handle housing 5 accommodate a brake assembly 80. The brake assembly 80 includes a brake 81 and a link unit 82. The brake 81 is located rearward from the rotor 18 in the motor housing 4. The link unit 82 is between the brake 81 and the switch lever 74. The link unit 82 links the operations of the switch lever 74 and the brake 81 with each other.

The brake 81 includes a base 83, a brake plate 84, a brake shoe 85, a shoe holder 86, a cap 87, and two coil springs 88.

The base 83 is coaxial with the output shaft 19. The base 83 is a bottomed cylinder that is open frontward. The base 83 includes four protruding pieces 89 protruding outward. The four protruding pieces 89 are arranged circumferentially evenly on the circumferential surface of the base 83.

As shown in FIG. 3, the two (left and right) protruding pieces 89 are fastened to the left and right elongated pieces 90 with screws from behind. The elongated pieces 90 hold the bearing holder 28 in the motor housing 4. As shown in FIG. 2, the two (upper and lower) protruding pieces 89 each have a boss 91 protruding frontward and integral with the corresponding protruding piece 89. Each boss 91 receives a cylindrical rubber pin 92. Each rubber pin 92 protrudes frontward from the corresponding boss 91 and is in contact with the rear surface of the corresponding one of the upper first controller 35 and the lower second controller 36. The rubber pins 92 press the first controller 35 and the second controller 36 against the upper front wall 51 and the lower front wall 58 to reduce rattle.

The brake plate 84 is a metal disc located in the base 83. The brake plate 84 is integral with a cylinder 93 extending frontward from the front surface of the brake plate 84 at the center. A connecting shaft 94 is located coaxially with and at the rear end of the output shaft 19. The connecting shaft 94 penetrates the bearing holder 28 and protrudes rearward. The cylinder 93 is fitted around the connecting shaft 94 to be rotatable together with the connecting shaft 94. The brake plate 84 includes multiple fins 95 standing on its rear surface. The fins 95 extend radially and arranged at circumferentially equal intervals.

The brake shoe 85 is a disc having substantially the same diameter as the brake plate 84. The brake shoe 85 applies a brake on the brake plate 84.

The shoe holder 86 holds the brake shoe 85 inside and is integral with the brake shoe 85. The shoe holder 86 is a bottomed cylinder that is open rearward. The shoe holder 86 is held in the base 83 in a manner movable forward and backward but is restricted from rotating.

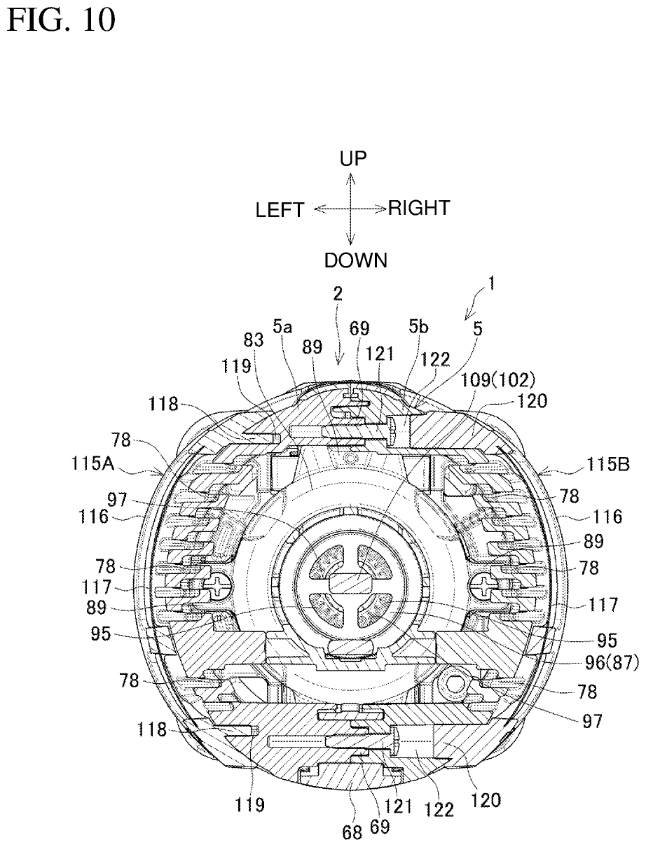

The cap 87 closes the rear end of the shoe holder 86. The cap 87 is movable forward and backward together with the shoe holder 86. The cap 87 includes a rear cylinder 96 with a smaller diameter at the center. The rear cylinder 96 penetrates the rear end of the base 83 and protrudes rearward. The rear cylinder 96 has multiple openings 97 (FIG. 10).

Each coil spring 88 is between the shoe holder 86 and the corresponding one of the left and right elongated pieces 90. The coil springs 88 urge the shoe holder 86 rearward. The shoe holder 86 and the cap 87 are urged to a rearward position (braking position) to press the brake shoe 85 against the front surface of the brake plate 84. A brake is thus applied on the output shaft 19 through the brake plate 84 and the connecting shaft 94 integral with the brake plate 84. At the braking position, the rear cylinder 96 on the cap 87 protrudes rearward from the base 83.

As shown in FIGS. 2 and 3, the link unit 82 includes a holder case 100, a slider 101, and a press lever 102.

As also shown in FIG. 7, the holder case 100 is held in the handle housing 5. The holder case 100 includes a pair of guide shafts 103 on the left and right.

The guide shafts 103 penetrate the slider 101 in the holder case 100. The slider 101 is held in the holder case 100 in a manner movable vertically. A coil spring 104 is wound around each guide shaft 103 to urge the slider 101 downward to a lower limit position in the holder case 100. The slider 101 includes a link piece 105 protruding rearward from the rear surface at its upper end. The link piece 105 protrudes rearward from the holder case 100. The link piece 105 engages with the upper front end of the switch lever 74 pivoted to the lower position. The slider 101 has a curved guide surface 106 at the front. The guide surface 106 inclines downward as it extends frontward.

The press lever 102 has a lower end supported on a connecting pin 107 in a manner pivotable forward and backward. The connecting pin 107 extends laterally. The press lever 102 includes a roller 108 at the upper rear end. The roller 108 is in contact with the guide surface 106 of the slider 101. The press lever 102 includes a pressing portion 109 protruding frontward at the upper front end. The pressing portion 109 comes in contact with the center of the rear cylinder 96 on the cap 87.

In the grinder 1, the switch lever 74 is pushed with the lock lever 76 coming off the unlocking position. The switch lever 74 then pushes, with its front end, the link piece 105, which then pushes the slider 101 in the link unit 82 upward along the guide shafts 103 against the urging force from the coil springs 104. The roller 108 on the press lever 102 then rolls forward relative to the guide surface 106 of the slider 101. The press lever 102 then pivots forward to cause the pressing portion 109 to press the cap 87 and the shoe holder 86 forward against the urging force from the coil springs 88. The brake shoe 85 then moves forward, together with the shoe holder 86, to be separate from the brake plate 84 (brake release position). This releases the brake on the output shaft 19 through the connecting shaft 94.

The pushed switch lever 74 also pushes the plunger 73 to turn on the switch 72. This starts power supply to the motor 16 to cause the output shaft 19 to rotate together with the rotor 18 with the brake released. The rotation is transmitted to the spindle 6 through the bevel gears 22 and 10, causing the grinding disc 13 to rotate.

While the motor 16 is being driven, the pickup coil 41 on the lower surface of the first controller 35 detects the rotation of the disc 30 (the rotation of the output shaft 19). The first controller 35 performs constant-speed rotation control on the motor 16 based on the detected rotational speed. The first controller 35 also monitors the rotational speed and the motor current to detect an overload.

In a normal operation, the green LED 40A alone is lit on the upper surface of the first controller 35. The green light through the lens 60 allows the operator to learn that the tool is normal.

In response to an abnormality, such as a power shutdown during use in the locked state followed by the restoration of power, the red LED 40B flashes on the upper surface of the first controller 35 without the motor 16 being driven. The red light through the lens 60 allows the operator to learn that the tool is abnormal and is not in a condition for use.

The output shaft 19 rotates to rotate the centrifugal fan 23, which draws outside air into the handle housing 5 through the inlet ports 78. The drawn air passes through the openings 97 in the cap 87 on the base 83 and outside the base 83 to enter the motor housing 4. The air passing inside and outside the base 83 passes outside the bearing holder 28 and between the stator 17 and the rotor 18 to cool the motor 16.

The air passes around the first and second controllers 35 and 36 as it passes through the upper holder 45 and the lower holder 46 outside the bearing holder 28. This cools the first and second controllers 35 and 36. After cooling the first and second controllers 35 and 36, the air passes through the through-holes 52 in the upper front wall 51 and the through-holes 59 in the lower front wall 58 to reach the motor 16.

The air then flows through the baffle plate 24 and through-holes (not shown) in the partition 20 to enter the gear housing 3 and is then discharged through the outlet 15.

The brake plate 84 includes the fins 95 radially extending on the rear surface. The brake plate 84 thus serves as a centrifugal fan rotating to generate airflow. This allows more effective cooling for the brake 81 in cooperation with the air passing inside the base 83.

The switch lever 74 released from being pushed releases the plunger 73 from being pushed to turn off the switch 72. The release also causes the slider 101 to slide to the lower limit position under the urging force from the coil spring 104. This causes the roller 108 to move upward relative to the guide surface 106 to reduce the pressing force on the cap 87 from the press lever 102. Urged by the coil springs 88, the shoe holder 86 and the cap 87 return to the rearward position (braking position) to cause the brake shoe 85 to come in contact with the brake plate 84. A brake is thus applied to the output shaft 19 through the brake plate 84 and the connecting shaft 94. The braking force is transmitted to the spindle 6 to immediately stop the grinding disc 13.

In the grinder 1 according to the embodiment, the controller is divided into the first controller 35 and the second controller 36. The first controller 35 receives the LEDs 40A and 40B and the pickup coil 41 (electrical components of the grinder 1) on the upper and lower surfaces (part of the outer surface). The LEDs 40A and 40B and the pickup coil 41 perform their electrical operations on the upper and lower surfaces of the first controller 35.

This structure uses fewer wires drawn from the first controller 35 that receives the electrical components, among the divided first and second controllers 35 and 36, thus allowing simple wiring. This structure involves less laborious assembly and a lower possibility of wire breakage.

The electrical components include LEDs 40A and 40B (light emitters) that emit light outside the housing 2 to indicate the operating state of the grinder 1. The light emitters are installable in a space-saving manner.

The lens 60 is insert molded (integrally molded) onto the housing 2 to guide light from the LEDs 40A and 40B outside. The lens 60 can thus be included without compromising sealing and insulation. The lens 60 can also reliably guide light from the LEDs 40A and 40B outside the housing 2.

The LEDs 40A and 40B indicate whether the operating state of the grinder 1 is normal or abnormal. The light from the LEDs 40A and 40B allows the operator to easily learn whether the operating state of the tool is normal or abnormal.

The electrical components include the pickup coil 41 (rotational speed sensor) for the motor 16. The rotational speed sensor 41 is installable in a space-saving manner.

The pickup coil 41 detects an overload on the motor 16. The first controller 35 can thus use the pickup coil 41 to easily detect an overload on the motor 16.

The pickup coil 41 performs constant-speed rotation control on the motor 16. The first controller 35 can thus use the pickup coil 41 to easily perform constant-speed rotation control on the motor 16.

The second controller 36, different from the first controller 35 receiving the electrical components, receives the heat-generating components such as triacs and FETs in a concentrated manner. The first controller 35 is thus less susceptible to heat. The second controller 36 includes the aluminum case 42. Thus, the second controller 36 receiving the heat-generating components in a concentrated manner can effectively dissipate heat.

The first and second controllers 35 and 36 are at symmetric positions with respect to a point, with the output shaft 19 of the motor 16 in between. The first and second controllers 35 and 36 can be effectively in the space around the output shaft 19.

The first and second controllers 35 and 36 extend along the output shaft 19 and are located between the motor 16 and the inlet ports 78 (inlets) in the housing 2. This structure allows effective cooling of the first and second controllers 35 and 36 using the cooling air for the motor 16.

A modification will now be described.

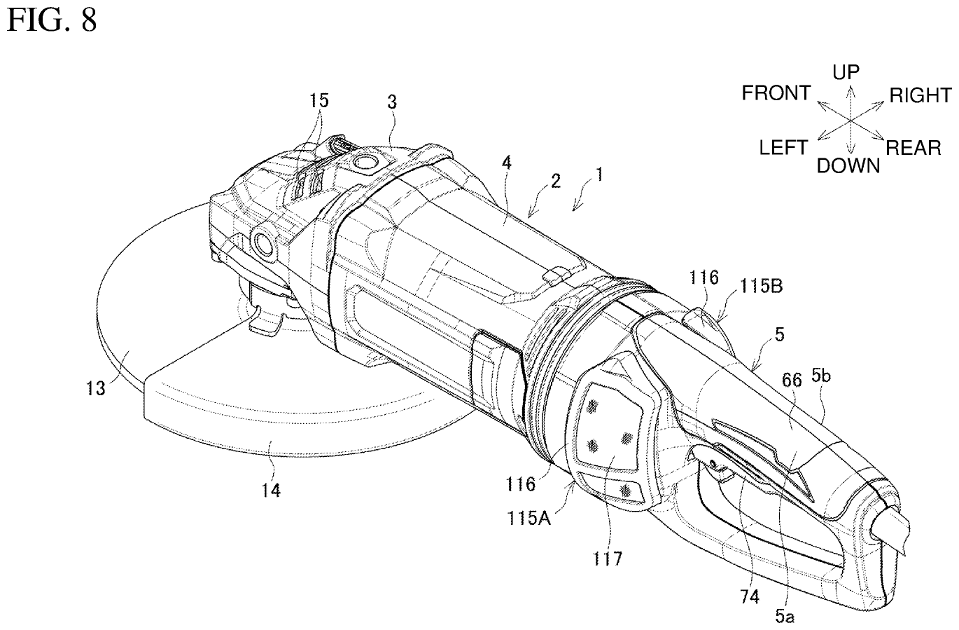

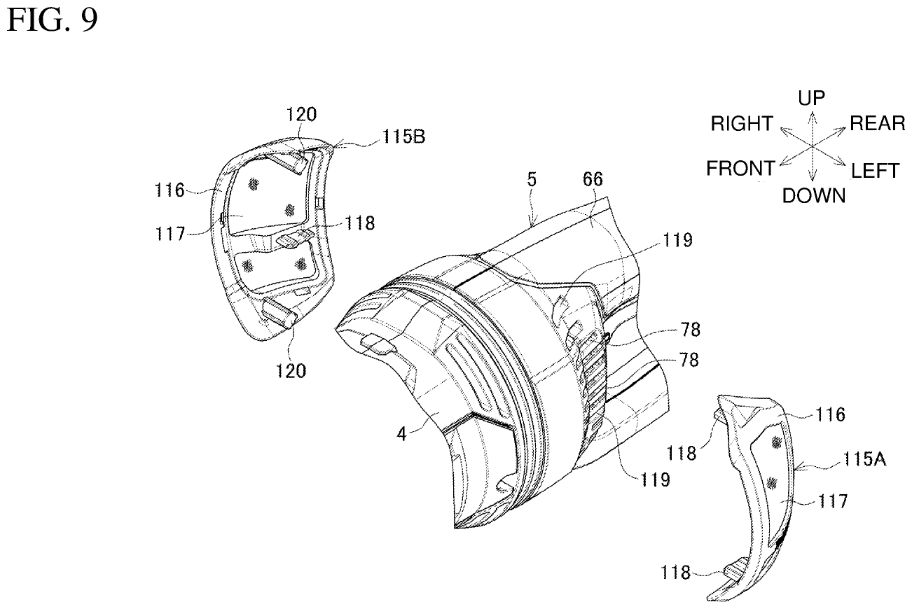

As shown in FIG. 8, the handle housing 5 may include a pair of covers 115A and 115B on the left and right surfaces. The covers 115A and 115B prevent dust and other foreign matter from entering through the inlet ports 78. As shown in FIG. 9, the covers 115A and 115B each include a frame 116 and a net 117. The frames 116 are each slightly larger than the area of the inlet ports 78 in the corresponding side surface of the handle housing 5. The frames 116 have curved surfaces along and in contact with the side surfaces of the handle housing 5. The nets 117 are stretched within the frames 116.

The left cover 115A includes three fitting ribs 118 extending in the front-rear direction at the top, bottom, and an intermediate position on the frame 116. The handle housing 5 has three fitting recesses 119 extending in the front-rear direction in an area other than the area of the inlet ports 78 in the left surface. Each fitting recess 119 receives the corresponding fitting rib 118.

As shown in FIG. 10, the fitting ribs 118 are fitted in the fitting recesses 119. This structure allows the cover 115A to be attached to the left surface of the handle housing 5 without using screws or other parts. This structure also allows easy detachment of the cover 115A.

The right cover 115B includes two circular projections 120 projecting leftward at the top and bottom of the frame 116. The frame 116 includes a fitting rib 118 between the circular projections 120. The fitting rib 118 is similar to those on the cover 115A.

As shown in FIG. 10, the handle housing 5 has circular recesses 122 above and below the area of the inlet ports 78 in the right surface. The circular recesses 122 receive screws 121. The screws 121 are placed in the upper and lower screw bosses 69 on the half housing 5a to join the half housing 5b to the half housing 5a. The handle housing 5 has a fitting recess 119 between the circular recesses 122 in an area other than the area of the inlet ports 78 in the right surface. The fitting recess 119 receives the fitting rib 118.

The circular projections 120 are placed in the circular recesses 122, and the fitting rib 118 is fitted in the fitting recess 119. This structure allows the cover 115B to be attached to the right surface of the handle housing 5 without using screws or other parts. This structure also allows easy detachment of the cover 115B.

In some embodiments, the handle housing may eliminate the fitting recesses. In this case, the fitting ribs on the left and right covers may be fitted in selected inlet ports aligning with the fitting ribs with optional screws.

The LEDs and the pickup coil may be located at any position on the first controller. The LEDs may be located on, for example, the rear, left, or right surface of the first controller. More LEDs or fewer LEDs than in the above embodiments may be used. Light emitters other than LEDs may be used. The lens may be other than an integrally molded lens. Similarly, the position of the pickup coil on the first controller may be modified as appropriate.

The second controller may include fins instead of projections to serve as the heat dissipator. A separate heat dissipator may be attached to the surface of the second controller. The heat dissipator may be eliminated.

The first and second controllers may have any size and shape other than those in the above embodiments. The first and second controllers each may have a rectangular shape elongated in the front-rear direction or a shape other than rectangular or square. The case may be eliminated.

The two controllers in the above embodiments are located above and below the output shaft. However, their positions may be modified. The two controllers may be located on the left and right of the output shaft. The two controllers may be aligned laterally or vertically instead of being located with the output shaft in between.

The controller may be divided into three or more controllers instead of two controllers. In this case, at least one controller may receive electrical components on the outer surface. For example, one of the three or more controllers may receive LEDs, and another controller may receive a pickup coil.

The rotational speed sensor may be used to prevent a kickback, or a phenomenon in which the tip tool hits a hard object and causes the tool body to bounce toward the operator.

The electrical components are not limited to the light emitters as an information output unit and the rotational speed sensor as an information input unit. For example, the information output unit on the outer surface of the controller may be an indicator for indicating the rotational speed of the motor or the remaining battery level. The information input unit on the outer surface of the controller may be a temperature sensor for detecting the temperature inside the housing, or may be an operation unit, such as a dial or a switch, operable to change the rotational speed of the motor. An accelerometer may also be used to prevent a kickback. The controller may receive either the information output unit or the information input unit.

For multiple electrical components, at least one electrical component may be located on the outer surface of the controller, and at least another electrical component may be located away from the controller and connected to the controller with a lead wire. This structure also uses fewer wires.

The rotary tool may include a housing without an anti-vibration member.

The brake assembly may have a structure modified as appropriate. The brake assembly may be located at the front of the output shaft instead of being located at the rear of the output shaft. The brake assembly may be eliminated.

The rotary tool may be powered by a battery pack. The rotary tool may include a brushless motor as the motor.

The rotary tool is not limited to a grinder but may be, for example, a polisher or a sander.

### REFERENCE SIGNS LIST

1 grinder
2 housing
3 gear housing
4 motor housing
5 handle housing
6 spindle
13 grinding disc
16 motor
19 output shaft
25 commutator
28 bearing holder
30 disc
31 permanent magnet
35 first controller
36 second controller
37, 42 case
38, 43 circuit board
40A, 40B LED
41 pickup coil
45 upper holder
46 lower holder
60 lens
66 handle
72 switch
74 switch lever
78 inlet port
80 brake assembly
81 brake
82 link unit
83 base
84 brake plate
85 brake shoe
86 shoe holder
87 cap
94 connecting shaft
100 holder case
101 slider
102 press lever
115A, 115B cover

What is claimed is:

1. A rotary tool, comprising:
a housing;
a motor accommodated in the housing;
a final output shaft accommodated in the housing and configured to receive a tip tool, the final output shaft being rotatable by the motor being driven; and
a plurality of controllers accommodated in the housing, the plurality of controllers including at least a first controller receiving an electrical component of the rotary tool on an outer surface of the first controller, the electrical component being configured to perform an electrical operation.

2. The rotary tool according to claim 1, wherein
the electrical component includes a light emitter configured to emit light outside the housing to indicate an operating state of the rotary tool.

3. The rotary tool according to claim 2, further comprising:
a lens configured to guide light from the light emitter outside, the lens and the housing being an integral piece.

4. The rotary tool according to claim 2, wherein
the light emitter indicates whether the operating state of the rotary tool is normal or abnormal.

5. The rotary tool according to claim 1, wherein
the electrical component includes a rotational speed sensor for the motor.

6. The rotary tool according to claim 5, wherein
the rotational speed sensor detects an overload on the motor.

7. The rotary tool according to claim 5, wherein
the rotational speed sensor performs constant-speed rotation control on the motor.

8. The rotary tool according to claim 1, wherein
the plurality of controllers include, other than the first controller, a second controller receiving a heat-generating component.

9. The rotary tool according to claim 1, wherein
the motor includes an output shaft,
the plurality of controllers include a second controller other than the first controller, and
the first controller and the second controller are located with the output shaft in between.

10. The rotary tool according to claim 9, wherein
the housing has an inlet, and
the first controller and the second controller extend along the output shaft and are located between the motor and the inlet.

11. The rotary tool according to claim 3, wherein
the light emitter indicates whether the operating state of the rotary tool is normal or abnormal.

12. The rotary tool according to claim 2, wherein
the electrical component includes a rotational speed sensor for the motor.

13. The rotary tool according to claim 3, wherein
the electrical component includes a rotational speed sensor for the motor.

14. The rotary tool according to claim 4, wherein
the electrical component includes a rotational speed sensor for the motor.

15. The rotary tool according to claim 6, wherein
the rotational speed sensor performs constant-speed rotation control on the motor.

16. The rotary tool according to claim 2, wherein
the plurality of controllers include, other than the first controller, a second controller receiving a heat-generating component.

17. The rotary tool according to claim 3, wherein
the plurality of controllers include, other than the first controller, a second controller receiving a heat-generating component.

18. The rotary tool according to claim 4, wherein
the plurality of controllers include, other than the first controller, a second controller receiving a heat-generating component.

19. The rotary tool according to claim 5, wherein
the plurality of controllers include, other than the first controller, a second controller receiving a heat-generating component.

20. The rotary tool according to claim 6, wherein
the plurality of controllers include, other than the first controller, a second controller receiving a heat-generating component.
